(19) United States
(12) Patent Application Publication
(10) Pub. No.: US 2022/0101044 A1
(43) Pub. Date: Mar. 31, 2022

(54) ARTIFICIAL INTELLIGENCE MODEL GENERATION USING DATA WITH DESIRED DIAGNOSTIC CONTENT

(71) Applicant: International Business Machines Corporation, Armonk, NY (US)

(72) Inventors: Jing Xu, Xi'an (CN); Xue Ying Zhang, Xi'an (CN); Si Er Han, Xi'an (CN); Xiao Ming Ma, Xi'an (CN); Ji Hui Yang, Beijing (CN)

(21) Appl. No.: 17/035,816

(22) Filed: Sep. 29, 2020

(51) Int. Cl. G06K 9/62; G06N 20/00

(52) U.S. Cl. CPC G06K 9/6219; G06K 9/6256; G06N 20/00; G06K 9/623; G06K 9/6262

(57) ABSTRACT

A computer receives a general predictive model and training data. The computer builds a clustering feature tree model to condense the training data into data groups. The computer applies a leave-one-out evaluation method to determine an impact value for each data groups with regard to said general predictive model. The computer identifies a diagnostic category for each data group selected from a list of categories including model-harmful data, model-neutral data, and model-helping data, in accordance with said impact value. The computer removes data in groups labelled as model-harmful from the training data and builds a modified general predictive model based on data in groups labelled as model-neutral or model-helping.

### BACKGROUND

The present invention relates generally to the field of machine learning, and more specifically, to the evaluation of data using models based on data group analysis.

Artificial Intelligence (AI) uses models that determine patterns within training data to determine likely behavior within additional sets of similarly-situated data. Proper selection of model characteristics (e.g., including choice of algorithm, hyperparameters, etc.) can improve the effectiveness of a given model as a tool for predicting data behavior. Model effectiveness is also impacted by the quality of training data provided. For example, good training data includes patterns that are aligned with desired model behavior and successfully reinforce the model being developed, while poor quality data includes information that either contradicts (or are simply misaligned with) desired model performance.

### SUMMARY

According to one embodiment, a computer-implemented method for evaluating data, includes receiving, by a computer, a general predictive model and training data. The computer builds a clustering feature tree model to condense said training data into data groups. The computer applies a leave-one-out evaluation method to determine an impact value for each of the data groups with regard to the general predictive model. The computer identifies a diagnostic category for each of said data groups selected from a list consisting of model-harmful data, model-neutral data, and model-helping data, in accordance with said impact value. The computer also removes data in groups labelled as model-harmful from the training data and builds a modified general predictive model based on data in groups labelled as model-neutral or model-helping. According to other aspects of the invention, the computer builds a specialized predictive model that corresponds to data in a data group labelled as model-helping. According to other aspects of the invention, the computer receives evaluation data and evaluates the evaluation data with the clustering feature tree model and assigns the evaluation data to one of the data groups in accordance with the evaluation. According to other aspects of the invention, the computer scores the evaluation data with the specialized predictive model if the evaluation data is in the data group to which the specialized predictive model corresponds. According to other aspects of the invention, the computer including scoring, by said computer, scoring said evaluation data with said modified general predictive model if said evaluation data is in a data group identified as model-harmful or model-neutral. According to other aspects of the invention, the computer provides output group-relevant features for each of the data groups. According to other aspects of the invention, the diagnostic categories are determined by relevance to a performance value. The model-harmful diagnostic category is characterized by negative performance values, the model-neutral diagnostic category is characterized by performance values which fall within a first range of positive values, and the model-helping category is characterized by performance values which fall within a second range of positive values, with the second range being more positive than the first range.

According to another embodiment, a system to evaluate data, comprises: a computer system comprising a computer readable storage medium having program instructions embodied therewith, the program instructions executable by a computer to cause the computer to: receive a general predictive model and training data; build a clustering feature tree model to condense said training data into data groups; apply a leave-one-out evaluation method to determine an impact value for each of said data groups with regard to said general predictive model; identify a diagnostic category for each of said data groups selected from a list consisting of model-harmful data, model-neutral data, and model-helping data, in accordance with said impact value; and remove data in groups labelled as model-harmful from said training data and building a modified general predictive model based on data in groups labelled as model-neutral or model-helping.

According to another embodiment a computer program product to evaluate data, includes a computer readable storage medium having program instructions embodied therewith, the program instructions executable by a computer to cause the computer to: receive, using said computer, a general predictive model and training data; build, using said computer, a clustering feature tree model to condense said training data into data groups; apply, using said computer, a leave-one-out evaluation method to determine an impact value for each of said data groups with regard to said general predictive model; identify, using said computer, a diagnostic category for each of said data groups selected from a list consisting of model-harmful data, model-neutral data, and model-helping data, in accordance with said impact value; and remove, using said computer, data in groups labelled as model-harmful from said training data and building a modified general predictive model based on data in groups labelled as model-neutral or model-helping.

In embodiments according to the present invention, a computer implemented method to optimize input component enablement for several participants in an electronic group meeting includes a computer that identifies a group of communication devices (e.g., computers, telephones, etc.) joined together for use by a group of meeting participants. Each of the communication devices has a microphone, each of the participants is associated with one of the microphones, and some of the participants are characterized by identification attributes (for example, participant name or subject matter expertise). The computer receives audio input from the participants via the microphones and measures certain quality-based attributes of the audio input to provide associated quality metrics. The audio input can include any audio throughput received by the computer, which can include background noise, a participant's voice, and meeting content, as well as audio signal quality assessments. The computer uses these metrics to determine whether any of the input exceeds a quality threshold and places microphones providing quality threshold-exceeding input into an active speaking mode. The computer also evaluates content of participant audio input and identifies a current concept of focus. The computer then places into an active speaking mode any microphones that are associated with participant having identification attributes that correspond to the current concept of focus.

In another embodiment of the invention, a system to optimize input component enablement for a plurality of communication devices each having an input component associated with at least one participant in an electronic group meeting, which comprises:

a computer system comprising a computer readable storage medium having program instructions embodied therewith. The program instructions are executable by a computer to cause the computer to: identify a plurality of communication devices, each having an audio input component, said audio input components each being associated with at least one of a plurality of a group of participants, wherein at least one of said participants is characterized by an identification attribute; receive an audio input from a first of said audio input components; measure preselected qualitative attributes of said audio input to provide a set of quality metrics; determine whether said set of quality metrics exceeds a threshold for quality; place into an active speaking mode said first audio input component when said set of quality metrics exceeds said threshold for quality; evaluate content of said audio input to identify a concept of focus; place into an active speaking mode any audio input component associated with one of said participants characterized by said identification attribute when said identification attribute corresponds to said identified concept of focus.

In another embodiment of the invention, a computer program product optimizes input component enablement for a plurality of participants in an electronic group meeting. The computer program product comprises a computer readable storage medium having program instructions embodied therewith. The program instructions are executable by a computer to cause the computer to: identify a plurality of communication devices, each having an audio input component, said audio input components each being associated with at least one of a plurality of group participants, wherein at least one of said participants is characterized by an identification attribute; receive an audio input from one of said audio input components; measure content and preselected qualitative attributes of said audio input to provide, respectively, a topic of focus and a set of quality metrics; determine whether said set of quality metrics exceeds a threshold for quality; and place into an active speaking mode any audio input component that is associated with one of said participants having an identification attribute corresponding to said topic of focus or for which said set of quality metrics exceeds said threshold for quality.

The present disclosure recognizes the shortcomings and problems associated with models that are developed and trained with data having poor diagnostic attributes. The current disclosure also recognizes that using high quality training data with appropriate diagnostic content is important, uses AI to identify to high quality training data, and generates models that properly reflect the training data provided.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are set forth as below as:

FIG. 1 is a schematic block diagram illustrating an overview of a system for data evaluation that analyzes training data to develop models based on training data groups having desired diagnostic content according to embodiments of the present invention.

FIG. 2 is a flowchart illustrating a method, according to aspects of the invention, of data evaluation that analyzes training data to develop models based on training data groups having desired diagnostic content using the system shown in FIG. 1.

FIG. 3 is a schematic representation of clustering feature (CF tree) model used to group data according to some aspects of the present invention.

FIG. 4 is a table showing exemplary data group cluster feature profiles according to embodiments of the present invention.

FIG. 5 is a graph showing exemplary ranges of relative importance values useful in determining diagnostic importance of training data groups according to embodiments of the present invention.

FIG. 6 is a schematic block diagram depicting a computer system according to an embodiment of the disclosure which may be incorporated, all or in part, in one or more computers or devices shown in FIG. 1, and cooperates with the systems and methods shown in FIG. 1.

FIG. 7 depicts a cloud computing environment according to an embodiment of the present invention.

FIG. 8 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a participant” includes reference to one or more of such participants unless the context clearly dictates otherwise.

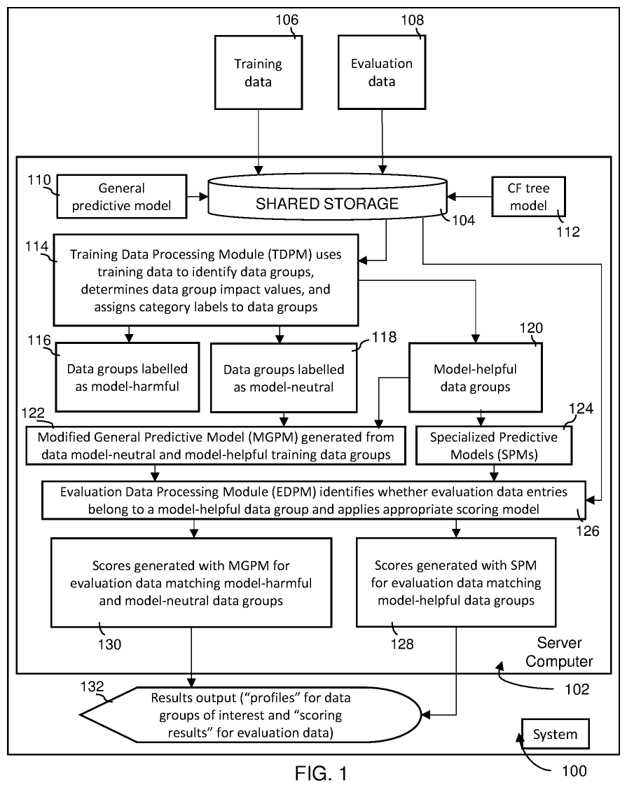

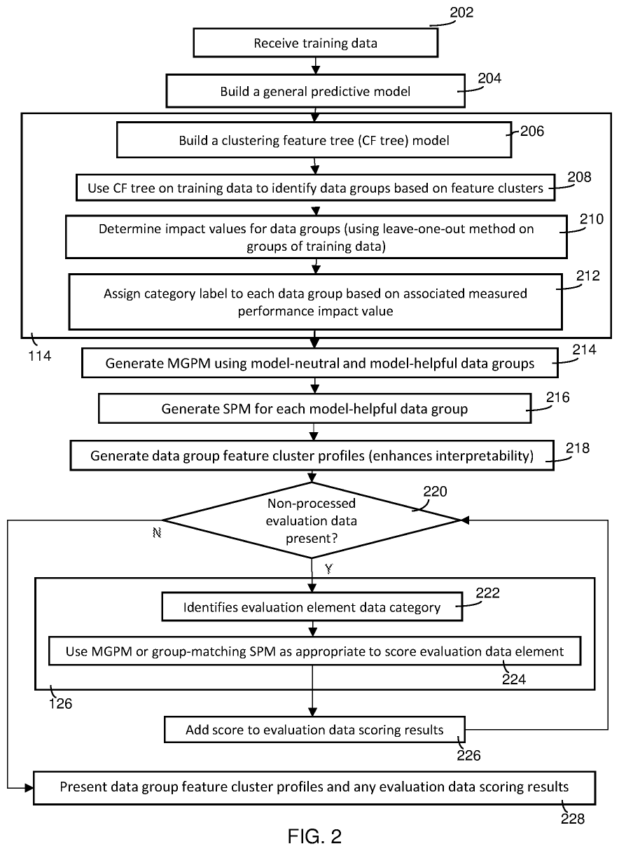

Now with combined reference to the Figures generally and with particular reference to FIG. 1 and FIG. 2, an overview of a method for data evaluation and modeling usable within a system 100 as carried out by a server computer 102 is shown. The server computer has optionally shared storage 104 and aspects that analyze training data and develop models based on training data groups having desired diagnostic content according to an embodiment of the present disclosure. The server computer 102 is communication with a source of training data 106 and evaluation data 108. As will be described more fully below, the training data 106 is used to generate predictive models, and these models are used to score evaluation data 108.

The server computer 102 includes a General Predictive Model (GPM) 110 and a clustering feature (CF tree) model 112 which are used in a Training Data Processing Module (TDPM) 114 to identify groups of data. The data groups are placed into one of three diagnostic categories (i.e., groups that reinforce the are model-harmful 116, groups that are model-neutral data 118, and groups that are model-helpful 120). It is possible to have several groups of data in each diagnostic category 116, 118, 120.

The server computer also includes a Modified General Predictive Model (MGPM) 122 based on the model-neutral and model-helpful training data groups 118, 120 (e.g., training data with groups of model-harmful data 116 removed) and one or more Specialized Predictive Models (SPMs) 124 that are each based respectively on one of the data groups labelled as a model-helpful data group 120.

The server computer 102 includes an Evaluation Data Processing Module (EDPM) 126 that identifies the correct scoring model 122, 124 to be used for a given element entry of evaluation data 108. In particular, the EDPM 126 determines whether a given element of evaluation data 108 belongs to one of the model-helpful data groups 120 and provides scores 128 for matching elements with the SPM 124 associated with the data group the element matches. The EDPM 108 will provide scores 130 for evaluation data elements 108 not matching one of the model-helpful data groups 120 (i.e., elements belonging to one of the model-harmful or model-neutral data groups 116, 118) with the MGPM 122.

The server computer 102 provides output 132 to a user or storage device. According to some aspects of the invention, the output 132 can include cluster profiles 402, 404, 406 (exemplary versions of which are shown in FIG. 4) for selected data groups categorized as model-helpful 120. According to other aspects of the invention, the output 132 can include evaluation data scores 128, 130.

Now with continued reference to FIG. 2, aspects of the method according to the present invention will be discussed in more detail. The server computer 102 receives, at block 202, training data 106 and builds, at block 204, the GPM 110 based on the training data. According to aspects of this invention, the GPM 110 can be produced in a typical manner selected by one skilled in this art.

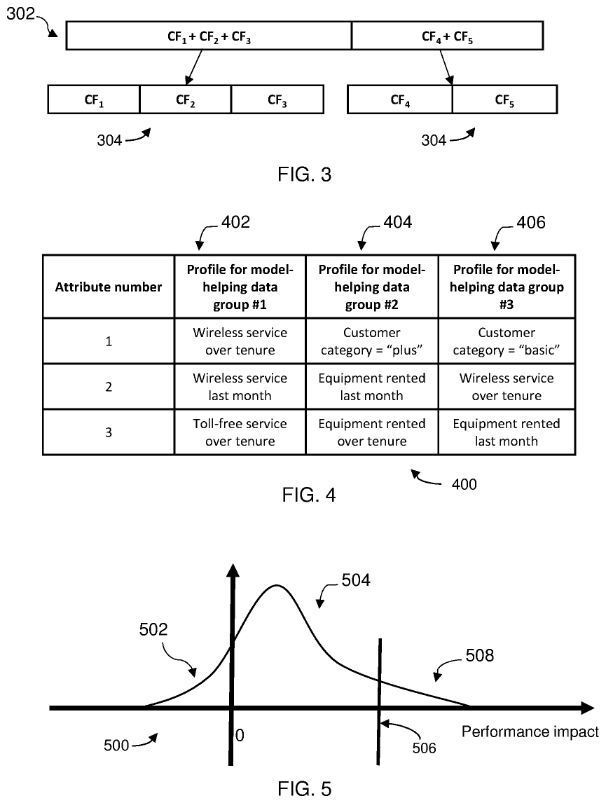

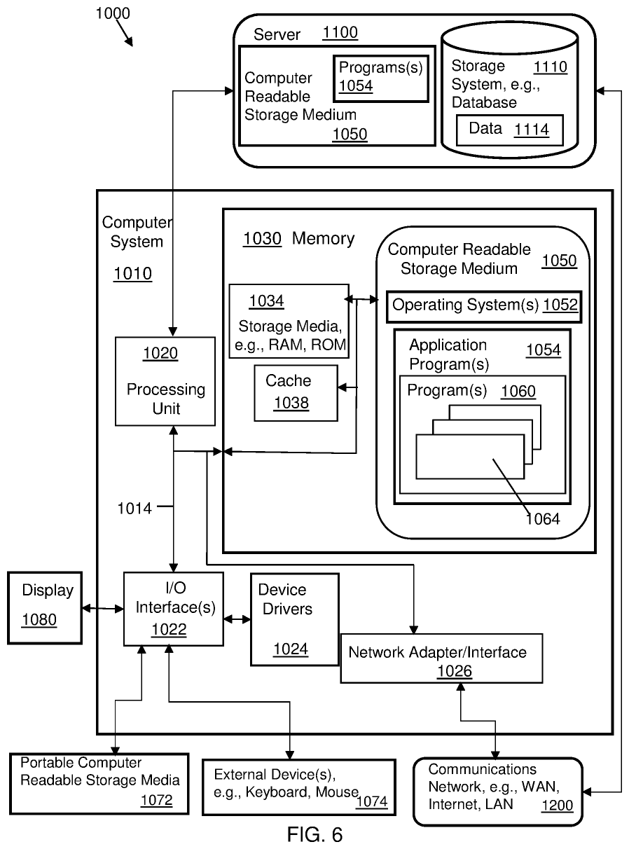

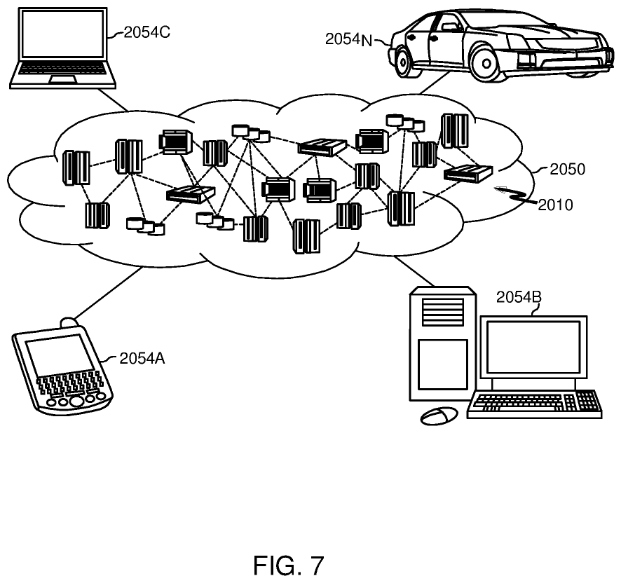

The server computer 102 passes the training data 202 and GPM 110 to the TDPM 114 for further processing. At block 206, the server computer 102 builds a CF tree 112 (shown schematically in FIG. 3 in a fashion known to those skilled in this field. Although the CF tree groups through hierarchical clustering and is effective even for large data sets, it noted that other clustering methods suitable for the data sets being processed may be selected by one skilled in this filed. With additional reference to FIG. 3, the CF tree shown includes one root node 302 and two leaf nodes 304. As is typical, entries in the CF tree correspond to a number of data records. The CF tree contains a cluster feature summary, as well as the number of records, mean and variance for each of possibly several continuous variables and the counts for each category of possibly several categorical variables. The sever computer 102, at block 208, applies the CF tree to the training data 106 and generates a collection of data groups from within the training data. An example CF tree is shown in FIG. 3, wherein the root node 302 has two entries which summarize the cluster features for each of the two leaf nodes 304. According aspects of the present invention, entries in the leaf nodes 304 correspond to data groups, and each data group is identified as belonging to one of three diagnostic categorized, based on a measured impact value the group on GPM 110 performance.

According to aspects of the invention, data group impact on GPM 110 performance is established through use of an assessment routine such as one known commonly in this field as the “leave-one-out” approach. In this approach, the data groups are iteratively removed from the training data 106 and performance of the GPM 110 is comparison to a reference performance value taken with all training data present. Through this comparison, the server computer 102, at block 210 determines a performance impact value for each data group. The data groups are then ranked according to performance impact value and assigned, at block 212, to a diagnostic category 116, 118, 120 as described below.

If performance (e.g., model accuracy, model response time, or another measurable attribute selected by one skilled in this field) of the GPM 110 improves when compared to the reference performance value (e.g., shows more than a 10% improvement in measured performance) with a given data group removed from the training data 106, the removed group of data is categorized as model-harmful and is placed in that diagnostic category 116. It is noted that model-harmful variation thresholds need not be limited to 10%; other amounts of change may be selected in accordance with the judgment of one skilled in this field. If performance (as described above) of the GPM 110 is reduced when compared to the reference performance value (e.g., shows more than a 10% degradation in measured performance) with a given data group removed from the training data 106, the removed group of data is categorized as model-helpful and is placed in that diagnostic category 120. It is noted that model-helpful variation thresholds need not be limited to 10%; other amounts of change may be selected in accordance with the judgment of one skilled in this field. It is noted that removal of some data groups may have only a slight impact on model performance. If removal of a given data group from test data 106 doesn't affect performance (as described above) of the GPM 110 significantly enough to be labeled as either model-harmful or model-helpful, the removed group of data is categorized as model-neutral and is placed in that diagnostic category 118.

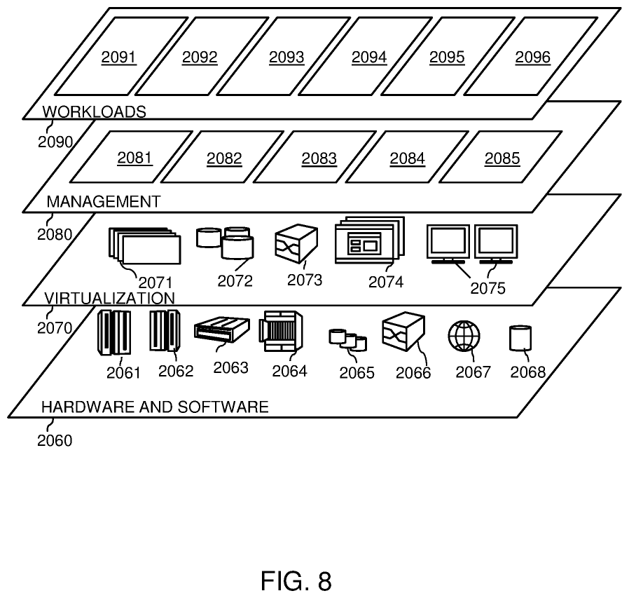

Alternatively, as shown in FIG. 8, diagnostic categories 16, 118, 120 may be assigned according to a ranges within an overall distribution 500 of performance impact values. For example, all data groups having a negative performance impact value 502 may be categorized as a model-harmful data group 116. Similarly, all data groups having a performance impact value within a range 504 that is positive and below a selected threshold of significance 506 (e.g., such as the mean value of measured performance impact plus twice the standard deviation, or some other value selected by one skilled in this field) may be categorized as a model-neutral data group 116. According to aspects of the invention, data groups having a performance impact value 508 above the selected threshold of significance 506 (as described above) may be categorized as model-helpful data groups 116.

The server computer 102, at block 214, establishes a revised set of training data by removing all data in the model-harmful data groups 116. The server computer 102 uses the revised training data set (which includes only data from the model-neutral and model-helpful data groups 118, 120) to build and train the MGPM 122. Because it is built and trained without diagnostically-harmful data 116, the MGPM can provide better scoring performance than the GPM 110.

The server computer 102, at block 216, generates an SPM 124 for each data group labeled as model-helpful 120. To generate an SPM, the server computer 102 selects one of the data sets labeled as data-helpful and uses the data in that data group to build and train a model which is very-well-suited to score evaluation data having a feature cluster profile that matches the profile associated with the modeled data group. Because it is built and trained on a group of diagnostically useful data, the SPM associated with a given data group performs especially well when used to score evaluation data having a profile that matches the profile of the associated data group. As used herein, the concept of a profile that matches means a profile of cluster features for which a given piece of evaluation data 108 would be assigned into a given model-helpful data group 120 if the assessed evaluation data record were originally received as a piece of training data.

The server computer 102, at block 218, generates data group cluster profiles (several examples of which are shown in FIG. 4 at 402, 404, and 406). These profiles are generated to ensure high interpretability for the revised models 122, 124 generated by the server computer 102. As seen in table 400, various attributes (e.g., a top three, or other quantity selected in accordance with the judgment of one skilled in this field) are collected and presented to show which data features are deemed to be most impactful for a given data group. Although table 400 shows profiles 402, 404, 406 for three model helpful data groups 120, profiles for more or different data groups 120 or groups data from different diagnostic categories 116, 118 may be shown. By showing which features are deemed most important, a user can confirm model use (or indicate preference for use of a model based on different data groups), thereby producing models that foster high levels of user confidence.

The server computer 102, at block 220, determines whether any non-processed evaluation data 108 is present. If non-processed evaluation data 108 is present, the server computer 102, will send that data to the MGPM 126. The server computer 102, at block 222, identifies, on a per-record basis, the appropriate diagnostic category for any unscored evaluation data 108. If a given record of evaluation data 108 is determined to have a profile that matches (as the concept is described above) a model-harmful or model-neutral data group 116, 118, then the server computer 102 scores the record, at block 224, with the MGPM 122. If the a given record of evaluation data 108 is determined to have a profile that matches (as the concept is described above) a model-helpful data group 120, then the server computer 102 scores the record, at block 224, with the SPM 124 associated with the matching model-helping data group. The server computer 102 adds the score for the now-processed evaluation data record 108 to a record of evaluation data scores and flow returns to block 220, where the server computer 102 determines whether any non-processed evaluation data 108 remains for scoring.

Once all evaluation data 108 is scored, the server computer 102, at block 228, presents selectable output 132 which is displayed and selectively stored for further use. According to aspects of the invention, the output 132 can include profiles 402, 404, 406 for selected data groups 116, 118, 120. According to some aspects of the invention, the output 132 can include scores for processed evaluation data 108.

Regarding the flowcharts and block diagrams, the flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Referring to FIG. 8, a system or computer environment 1000 includes a computer diagram 1010 shown in the form of a generic computing device. The method 100, for example, may be embodied in a program 1060, including program instructions, embodied on a computer readable storage device, or computer readable storage medium, for example, generally referred to as memory 1030 and more specifically, computer readable storage medium 1050. Such memory and/or computer readable storage media includes non-volatile memory or non-volatile storage. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure. It is also understood that the control system 70 (shown in FIG. 8) can include all or part of the computer system 1010 and its components, and/or the control system can communicate with all or part of the computer system 1010 and its components as a remote computer system, to achieve the control system functions described in the present disclosure. It is also understood that the one or more communication devices 110 shown in FIG. 1 similarly can include all or part of the computer system 1010 and its components, and/or the communication devices can communicate with all or part of the computer system 1010 and its components as a remote computer system, to achieve the computer functions described in the present disclosure.

One or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 8, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 8 are intended to be illustrative only and that computing nodes 2010 and cloud computing environment 2050 can communicate with any type of computerized device over any type of network and/or network addressable connection (e.g., using a web browser).

Referring now to FIG. 8, a set of functional abstraction layers provided by cloud computing environment 2050 (FIG. 8) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and analyzing training data to develop models based on training data groups having desired diagnostic content 2096.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method for evaluating data, comprising:
receiving, by said computer, a general predictive model and training data;
building, by said computer, a clustering feature tree model to condense said training data into data groups;
applying, by said computer, a leave-one-out evaluation method to determine an impact value for each of said data groups with regard to said general predictive model;
Identifying, by said computer, a diagnostic category for each of said data groups selected from a list consisting of model-harmful data, model-neutral data, and model-helping data, in accordance with said impact value; and
removing, by said computer, data in groups labelled as model-harmful from said training data and building a modified general predictive model based on data in groups labelled as model-neutral or model-helping.

2. The method of claim 1, further including building, by said computer, a specialized predictive model corresponding to data in a data group labelled as model-helping.

3. The method of claim 2, further including
receiving, by said computer, evaluation data; and
evaluating, by said computer, said evaluation data with said clustering feature tree model and assigning said evaluation data to one of said data groups in accordance with said evaluation.

4. The method of claim of 3, further including scoring, by said computer, said evaluation data with said specialized predictive model if said evaluation data is in the data group to which said specialized predictive model corresponds.

5. The method of claim of 3, further including scoring, by said computer, said evaluation data with said modified general predictive model if said evaluation data is in a data group identified as model-harmful or model-neutral.

6. The method of claim 1, further including providing as output, by said computer, group-relevant features for at least one of said data groups.

7. The method of claim 1, wherein said diagnostic categories are determined by relevance to a performance value, said model-harmful diagnostic category being characterized by negative performance values, said model-neutral diagnostic category being characterized by performance values which fall within a first range of positive values, and said model-helping category is characterized by performance values which fall within a second range of positive values, said second range being more positive than said first range.

8. A system to evaluate data, which comprises:
a computer system comprising a computer readable storage medium having program instructions embodied therewith, the program instructions executable by a computer to cause the computer to:
receive a general predictive model and training data;
build a clustering feature tree model to condense said training data into data groups;
apply a leave-one-out evaluation method to determine an impact value for each of said data groups with regard to said general predictive model;
identify a diagnostic category for each of said data groups selected from a list consisting of model-harmful data, model-neutral data, and model-helping data, in accordance with said impact value; and
remove data in groups labelled as model-harmful from said training data and building a modified general predictive model based on data in groups labelled as model-neutral or model-helping.

9. The system of claim 8, wherein said instruction further cause said computer to build a specialized predictive model corresponding to data in a data group labelled as model-helping.

10. The system of claim 9, wherein said instruction further cause said computer to receive evaluation data;
evaluate said evaluation data with said clustering feature tree model; and
assign said evaluation data to one of said data groups in accordance with said evaluation.

11. The system of claim of 10, wherein said instruction further cause said computer to score said evaluation data with said specialized predictive model if said evaluation data is in the data group to which said specialized predictive model corresponds.

12. The system of claim of 10, wherein said instruction further cause said computer to score said evaluation data with said modified general predictive model if said evaluation data is in a data group identified as model-harmful or model-neutral.

13. The system of claim 8, wherein said instruction further cause said computer to provide as output group-relevant features for at least one of said data groups.

14. The system of claim 8, wherein said diagnostic categories are determined by relevance to a performance value, said model-harmful diagnostic category being characterized by negative performance values, said model-neutral diagnostic category being characterized by performance values which fall within a first range of positive values, and said model-helping category is characterized by performance values which fall within a second range of positive values, said second range being more positive than said first range.

15. A computer program product to evaluate data, the computer program product comprising a computer readable storage medium having program instructions embodied therewith, the program instructions executable by a computer to cause the computer to:
receive, using said computer, a general predictive model and training data;
build, using said computer, a clustering feature tree model to condense said training data into data groups;
apply, using said computer, a leave-one-out evaluation method to determine an impact value for each of said data groups with regard to said general predictive model;
identify, using said computer, a diagnostic category for each of said data groups selected from a list consisting of model-harmful data, model-neutral data, and model-helping data, in accordance with said impact value; and
remove, using said computer, data in groups labelled as model-harmful from said training data and building a modified general predictive model based on data in groups labelled as model-neutral or model-helping.

16. The computer program product of claim 15, wherein said instruction further cause said computer to build a specialized predictive model corresponding to data in a data group labelled as model-helping.

17. The computer program product of claim 16, wherein said instruction further cause said computer to
receive evaluation data;
evaluate said evaluation data with said clustering feature tree model; and
assign said evaluation data to one of said data groups in accordance with said evaluation.

18. The computer program product of claim of 17, wherein said instruction further cause said computer to score said evaluation data with said specialized predictive model if said evaluation data is in the data group to which said specialized predictive model corresponds.

19. The computer program product of claim of 17, wherein said instruction further cause said computer to score said evaluation data with said modified general predictive model if said evaluation data is in a data group identified as model-harmful or model-neutral.

20. The computer program product of claim 15, wherein said instruction further cause said computer to provide as output group-relevant features for at least one of said data groups.
